(19) United States
(12) Patent Application Publication
(10) Pub. No.: US 2018/0060845 A1
(43) Pub. Date: Mar. 1, 2018

(54) OMNI-CHANNEL COLLABORATION INFRASTRUCTURE

(71) Applicant: NCR Corporation, Duluth, GA (US)

(72) Inventor: Andrew Monaghan, Dundee (GB)

(21) Appl. No.: 15/251,634

(22) Filed: Aug. 30, 2016

(51) Int. Cl. G06Q 20/10; H04L 29/08; G06Q 20/18

(52) U.S. Cl. CPC G06Q 20/1085; H04L 67/42; G06Q 20/18; H04L 67/141

(57) ABSTRACT

Omni-Channel experiences provide convenience to consumers by allowing the consumer to start and complete a transaction on a channel that is most convenient to them. This can entail a transaction being shared across two or more channels, or between a consumer and a staff member. Embodiments herein provide an infrastructure that allows a transaction to be shared in (near) real-time across channels allowing a cooperative, responsive experience that can be used to improve a number of consumer experiences. Note that in some embodiments a channel is a communication channel, device, application, or app through which a consumer is able to communicate, such as with a teller, clerk, other customer such as a spouse or child, a support desk, an automated teller, and the like.

### BACKGROUND INFORMATION

Consumers today can, for the most part, be expected to have a mobile device in their possession at virtual all times that allows them to access and upload data over the Internet. This provides new opportunities to enhance consumer experiences and for businesses and other entities to leverage this capability to their advantage. Such advantages may include quicker response to consumer inquiries and service needs and shorter lines at service points. However, such solutions to date have been very specific at hand and have failed to provide a generic infrastructure that is at least somewhat agnostic to the task at hand, devices to be integrated, and the like.

### SUMMARY

Omni-Channel experiences provide convenience to consumers by allowing the consumer to start and complete a transaction on a channel that is most convenient to them. This can entail a transaction being shared across two or more channels, or between a consumer and a staff member. Embodiments herein provide an infrastructure that allows a transaction to be shared in (near) real-time across channels allowing a cooperative, responsive experience that can be used to improve a number of consumer experiences. Note that in some embodiments a channel is a communication channel, device, application, or app through which a consumer is able to communicate, such as with a teller, clerk, other customer such as a spouse or child, a support desk, an automated teller, and the like. Examples may include anything from human interaction with a human teller supported by a computer application, a self-service terminal (SST) such as an automated teller machine (ATM), a mobile device app, an online banking session, and the like.

One such embodiment, in the form of a method, includes providing a set of services on a server accessible via a network to end-point applications that enable initiating, transacting, and ending collaboration sessions. This embodiment further includes conducting a collaborative session on the server over the network between at least two end-point applications, The session in such embodiments may be initiated by a first end-point application and joined by a second end-point application. The first and second end-point applications generally subscribe to data processing events from the server that receives data processing event data published to the server by the first and second end-point applications.

Another method embodiment includes receiving an invitation to join a collaborative session mediated by services hosted on a server over a network with a customer end-point application. The method may then transmit an acceptance of the invitation via the network in response to received acceptance input and subsequently receive via the network and present, within a user interface, collaborative session data with regard to at least one transaction being conducted within the collaborative session. This method may also include transmitting data representative of input received within the user interface with regard to the at least one transaction over the network to the server.

A further embodiment, in the form of a system, includes at least one network interface device, at least one processor, and at least one memory device storing instructions executable by the at least one processor to perform data processing activities. The data processing activities, in some embodiments, include providing a set of services accessible via the at least one network interface device to end-point applications that enable transacting collaboration sessions. The data processing activities may also include facilitating a session via the services between at least two end-point applications, the session initiated by a first end-point application and joined by a second end-point application.

### BRIEF DESCRIPTION OF THE DRAWINGS

FIG. 1 is a logical block diagram of system architecture, according to an example embodiment.

FIG. 2 is a block diagram of a computing device, according to an example embodiment.

FIG. 3 is a block flow diagram of a method, according to an example embodiment.

FIG. 4 is a block flow diagram of a method, according to an example embodiment.

### DETAILED DESCRIPTION

Omni-Channel experiences provide convenience to consumers by allowing the consumer to start and complete a transaction on a channel that is most convenient to them. This can entail a transaction being shared across two or more channels, or between a consumer and a staff member. Embodiments herein provide an infrastructure that allows a transaction to be shared in (near) real-time across channels allowing a cooperative, responsive experience that can be used to improve a number of consumer experiences. Note that in some embodiments a channel is a communication channel, device, application, or app through which a consumer is able to communicate, such as with a teller, clerk, other customer such as a spouse or child, a support desk, an automated teller, and the like. Examples may include anything from human interaction with a human teller supported by a computer application, a self-service terminal (SST) such as an automated teller machine (ATM), a mobile device app, an online banking session, and the like.

Omni-Channel goes beyond multi-channel where transactions and services are provided consistently across multiple channels. The essence of omni-channel, in some embodiments, is being able to share a transaction across multiple channels—this flexibility allows a consumer to start a transaction on one channel and complete it on another. Examples of this type of interaction include:
Prestaging a transaction on a mobile device and fulfilling the transaction using an ATM;
Account Opening, e.g., starting a transaction with a sales and service customer advisor in a branch and being able to cooperatively complete the forms using a consumer's mobile device; and
Teller assistance where a transaction is started by a consumer at an ATM, e.g., requests a high value transaction that need additional authorization and that authorization is completed by a staff member on a tablet or by the consumer via their mobile phone.
   Each of these examples demonstrates the cooperation of multiple channels or users to complete the transaction.

Embodiments herein provide such capabilities with a collaboration infrastructure. Previously, such communication has been handled through specific point-to-point integrations. Conversely, embodiments herein are enabled by a generalized collaboration infrastructure that can be used to address the class of omni-channel collaboration experiences.

There are in essence two fundamental types of collaboration:
Channel to channel collaboration: where a transaction can be started on one channel and shared in real time to another (for example, prestaging a transaction on a mobile device and fulfilling it on an ATM); and
Consumer to staff member collaboration: where a transaction can be started by one user and shared in real time to another (for example, account opening started by a staff member and shared in real time to a consumer's mobile device).

These collaboration embodiments can be combined to provide more complex scenarios. For example:
1. starting an ATM withdrawal transaction at a mobile device;
2. attempting to fulfill the transaction at an ATM; and
3. a teller providing a consumer's identity on a tablet device and overriding limits.

In this example the consumer via a mobile device app, the ATM, and the staff member all collaborate on the transaction and each communicate via a distinct channel.

The collaboration infrastructure allows channels to collaborate on a transaction—receiving a continuous stream of events that allow the channel to reflect the current transaction state (responsive UI) and to modify that state. Ultimately preparing a transaction for execution and then where appropriate fulfilling the transaction.

The Omni-Channel experience provides the capability to start a transaction on one channel and complete it on another. The embodiments herein detail services that are used by each of the channels to:
start a session (an interaction with a channel consisting of one or more transactions);
start a transaction;
allow the transaction state to be collaborated and shared across channels;
allow the transaction to be executed;
the result of the transaction to be shared;
further updates to the transaction state based upon the result;
transaction to be re-executed;
transaction to be ended; and
session ended.

In some embodiments, these services are provided by an enterprise application that executes in a data-center. The application can be run across multiple servers to provide scalability and resilience. The application offers a set of API's that can be called by channels for:
creation of a session and termination of a session;
create a transaction and update the transaction state and destroy a transaction;
to enumerate the available set of sessions and transactions;
to request permission to subscribe to a session and receive events as transactions are started;
to request permission to subscribe to a transaction and receive events as its state changes; and
to request permission to subscribe to the creation and destruction of transactions, among others in some embodiments.

In such embodiments, a channel can create and provide a user a responsive user interface to these events allowing the channel to
provide a responsive user interface to the user of a channel of in-flight transactions; and
provide a responsive user interface to the state of a specific transaction.

The enterprise application may use a publish and subscribe architecture to allow channel applications (e.g., mobile device apps, ATM and SST applications, etc.) to subscribe and react to changes in the session and transaction state. The channel application uses these events to keep the channel user experience up to date with the progress of the transaction.

Data structures for the session and transaction may be a combination on session/transaction specific data structures and generic structures (key value pairs) to allow the enterprise application to be able to share any type of transaction. Channel applications subscribe to transaction state change events that notify changes to the data structures allowing the update of the user experience.

The enterprise application may also enforce security during the enumeration and subscription to sessions and transactions. For example, in a transaction that is shared between a mobile device and an ATM the channel application may be required to provide an authentication token from the mobile service and the cardholders ATM card number for both channels to participate in a transaction. The enforcement of security may be applied through configuration of the enterprise application.

These and other embodiments are described herein with reference to the figures.

In the following detailed description, reference is made to the accompanying drawings that form a part hereof and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

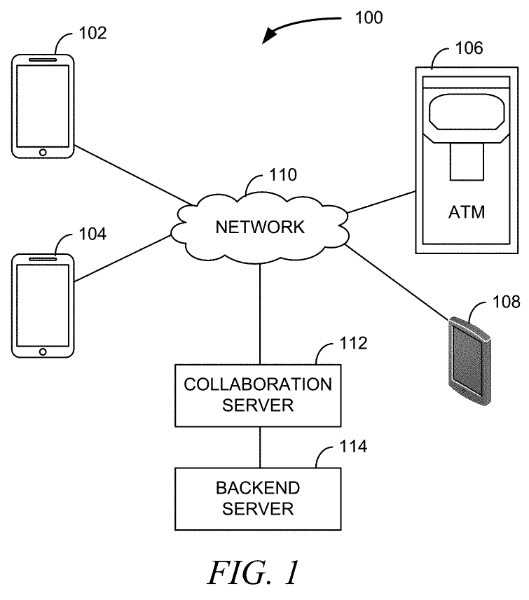

FIG. 1 is a logical block diagram of system 100 architecture, according to an example embodiment. The system 100 includes mobile devices, such as smartphones 102, 104 and tablet 108. The system 100 also includes a self-service terminal (SST), such as automated teller machine (ATM) 106. In addition to other functions, these devices connect over a network 110 to a collaboration server 112, which in turn is also connected to a backend server 114 that provides access for the collaboration server 112 to transaction data and processes.

In some embodiments, the collaboration sever 112 exposes collaboration services through an application programming interface (API), web services, or the like to the other devices over the network 110 to enable the devices to participate in collaboration sessions, such as may be conducted around or with a transactions. For example, a customer may desire to conduct a transaction on the ATM 106, but there may be a line. The customer may use their mobile device, such as smartphone 102, to access a banking app, enter details about the transaction to be conducted (e.g., withdraw $200 and deposit checks in the amount of $50). The data may then be transmitted to the collaboration server 112 via the network 110 to initiate and pre-stage the transaction at the ATM 106. The customer may then reach the ATM 106 and the ATM 106 will already be in possession of the pre-staged transaction data and the ATM 106 will instruct the customer to proceed.

However, before completing the session at the ATM 106 may provide an offer for a loan to the customer which the customer accepts. The loan application may be provided to the customer on their smartphone 102. via the collaboration server 112 either by the ATM 106 or in response to a request by the ATM 106. The customer may then complete the application on their smartphone 102, which is likely more efficient for the customer and for utilization of the ATM 106. Part of the application process though may include verification of the customer's identity by looking at a government issued identification card, such as a driver's license. For that to happen, a human teller may be requested to join the collaboration session through a message from the collaboration server 112 to the teller's mobile device, such as tablet 108. The tablet 108 in such embodiments includes an app that is added as a subscriber to the collaboration session and receives transaction data and transaction status data published by the collaboration server 112 either as received or as calculated or otherwise determined. The teller may approach the customer at the ATM 106 or when located elsewhere in a bank facility to view the customer's identification card and enter data verifying the customer's identity into the app which is then transmitted over the network 110 to the collaboration server 112 and may be updated to the backend server 114. In some such embodiments though, input may be need from another individual, such as a spouse of the customer for a mortgage application, opening a new bank or investment account, and the like. In such instances, the spouse or other individual may be added to the collaboration session via their smartphone 104.

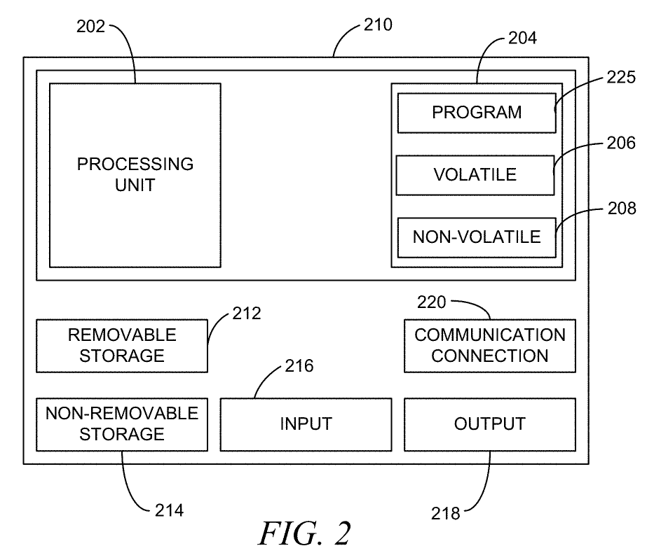

FIG. 2 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 210, may include a processing unit 202, memory 204, removable storage 212, and non-removable storage 214. Although the example computing device is illustrated and described as computer 210, the computing device may be in different forms in different embodiments. :For example, the computing device may instead be a smartphone, a tablet, smartwatch, or other computing device including the same or similar elements as illustrated and described with regard to FIG. 2. Devices such as smartphones, tablets, and smartwatches are generally collectively referred to as mobile devices. Further, although the various data storage elements are illustrated as part of the computer 210, the storage may also or alternatively include cloud-based storage accessible via a network, such as the Internet.

Returning to the computer 210, memory 204 may include volatile memory 206 and non-volatile memory 208. Computer 210 may include—or have access to a computing environment that includes a variety of computer-readable media, such as volatile memory 206 and non-volatile memory 208, removable storage 212 and non-removable storage 214. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 210 may include or have access to a computing environment that includes input 216, output 218, and a communication connection 220. The input 216 may include one or more of a touchscreen, touchpad, mouse, keyboard, camera, one or more device-specific buttons, one or more sensors integrated within or coupled via wired or wireless data connections to the computer 210, and other input devices. The computer 210 may operate in a networked environment using a communication connection 220 to connect to one or more remote computers, such as database servers, web servers, and other computing device. An example remote computer may include a personal computer (PC), server, router, network PC, a peer device or other common network node, or the like. The communication connection 220 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 220 may also or alternatively include a transceiver device, such as a BLUETOOTH® device that enables the computer 210 to wirelessly receive data from and transmit data to other BLUETOOTH™ devices.

Computer-readable instructions stored on a computer-readable medium are executable by the processing unit 202 of the computer 210. A hard drive (magnetic disk or solid state), CD-ROM, and RAM are some examples of articles including a non-transitory computer-readable medium. For example, various computer programs 225 or apps, such as one or more applications and modules implementing one or more of the methods illustrated and described herein or an app or application that executes on a mobile device or is accessible via a web browser, may be stored on a non-transitory computer-readable medium.

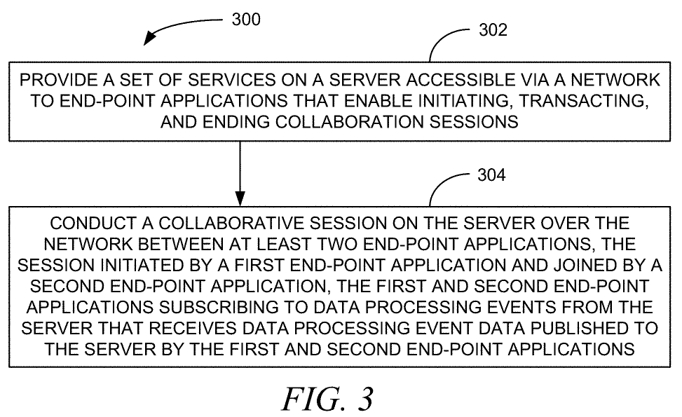

FIG. 3 is a block flow diagram of a method 300, according to an example embodiment. The method 300 is an example of a method that may be performed by the collaboration server 112 of FIG. 1.

The method 300 includes providing 302 a set of services on a server accessible via a network to end-point applications that enable initiating, transacting, and ending collaboration sessions. The end point-applications are applications that may be deployed to and execute on mobile devices, SSTs, and other devices that participate in collaboration sessions, such as the mobile devices 102, 104, 108 and the ATM 106 of FIG. 1. The method 300 further includes conducting 304 a collaborative session on the server over the network between at least two end-point applications. The session of such embodiments may be initiated by a first end-point application and joined by a second end-point application. In some such embodiments, the first and second end-point applications subscribe to data processing events from the server that receives data processing event data published to the server by the first and second end-point applications. In some embodiments, data is also published to the server by other programs and devices over the network, such as by a transaction processing system of a bank or other entity.

In some embodiments of the method 300, the set of services include services for initiating a session, adding a transaction to a session, publishing of session and transaction data processing event data, subscribing to session and transaction data processing event data, sharing of content, requesting and receiving input, ending a transaction, and ending a session.

In some embodiments, the first end-point application is an application tailored to a first user-type and the second end-point application is tailored to a second user-type. For example, the first and second end-point applications may be tailored for use by customers, tellers, clerks, warehouse staff, supervisors, customers below or above certain ages, SST users, ATM users, and the like.

In some further embodiments, the method 300 further includes receiving a request by the server over the network from the first end-point application to provide an electronic form to the second end-point application. The server may then retrieve the electronic form from data storage and transmit the retrieved electronic form over the network to the second end-point application. Subsequently, the server may receive the for electronic form populated with data over the network from the second end-point application. The form in such embodiments has typically been completed by the customer with their respective end-point application that executes on their personal device, such as a smartphone. The method 300 of such embodiments may further include the server processing the received electronic form populated with data to store the data populated into the form in a database. In some embodiments, the server forwards the received form data to another process or other server to perform the processing.

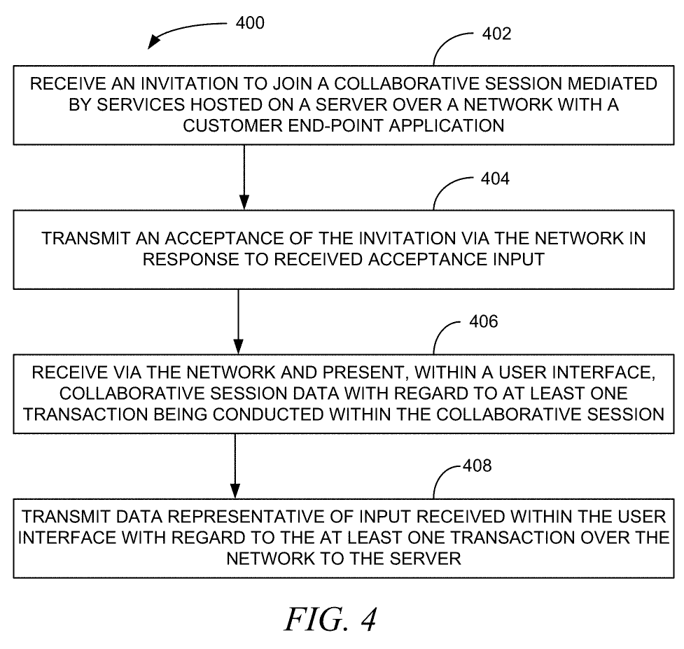

FIG. 4 is a block flow diagram of a method 400, according to an example embodiment. The method 400 is an example of a method that maybe performed by one or more of the collaboration apps or applications that may be deployed to smartphone 102, 104, tablet 108, and ATM 106 of FIG. 1.

The method 400 includes receiving 402 an invitation to join a collaborative session mediated by services hosted on a server over a network with a customer end-point application. The invitation is generally received as an electronic message with data about the collaborative session and connection data for connecting. The method 400 further includes transmitting 404 an acceptance of the invitation via the network in response to received acceptance input and receiving 406 via the network and presenting, within a user interface, collaborative session data with regard to at least one transaction being conducted within the collaborative session. The method 400 may then transmit 408 data representative of input received within the user interface with regard to the at least one transaction over the network to the server.

In some embodiments of the method 400, the data representative of input received within the user interface with regard to the at least one transaction includes input required for the at least one transaction to be processed by a backend system.

In some embodiments of the method 400, customer end-point application is a mobile banking app that executes on a customer mobile device. Further, the method 400 may be performed by an app tailored to perform session functions of a bank teller, a bank customer, a retailer customer or clerk, and the like.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
providing a set of services on a server accessible via a network to end-point applications that enable initiating, transacting, and ending collaboration sessions; and
conducting a collaborative session on the server over the network between at least two end-point applications, the session initiated by a first end-point application and joined by a second end-point application, the first and second end-point applications subscribing to data processing events from the server that receives data processing event data published to the server by the first and second end-point applications.

2. The method of claim 1, wherein the set of services include services for initiating a session, adding a transaction to a session, publishing of session and transaction data processing event data, subscribing to session and transaction data processing event data, sharing of content, requesting and receiving input, ending a transaction, and ending a session.

3. The method of claim 1, wherein the end-point applications include a self-service terminal (SST) application that executes on a computing device that controls operation of an SST.

4. The method of claim 3, wherein the self-service terminal is an Automated Teller Machine (ATM).

5. The method of claim 1, wherein the first end-point application is an application tailored to a first user-type and the second end-point application is tailored to a second user-type.

6. The method of claim 5, wherein:
the collaborative session is joined by a third end-point application, the third end-point application executes on a self-service terminal (SST) to control operation of the SST.

7. The method of claim 1, further comprising:
receiving a request over the network from the first end-point application to provide an electronic form to the second end-point application;
retrieving the electronic form from data storage; and
transmitting the retrieved electronic form over the network to the second end-point application.

8. The method of claim 7, further comprising:
receiving the for electronic form populated with data over the network from the second end-point application.

9. The method of claim 8, further comprising:
processing the received electronic form populated with data to store the data populated into the form in a database.

10. A method comprising:
receiving an invitation to join a collaborative session mediated by services hosted on a server over a network with a customer end-point application;
transmitting an acceptance of the invitation via the network in response to received acceptance input;
receiving via the network and presenting, within a user interface, collaborative session data with regard to at least one transaction being conducted within the collaborative session; and
transmitting data representative of input received within the user interface with regard to the at least one transaction over the network to the server.

11. The method of claim 10, wherein the data representative of input received within the user interface with regard to the at least one transaction includes input required for the at least one transaction to be processed by a backend system.

12. The method of claim 10, wherein the customer end-point application is a mobile banking app that executes on a customer mobile device.

13. The method of claim 12, wherein the method is performed by an app tailored to perform session functions of a bank teller that executes on a bank teller mobile device.

14. The method of claim 10, wherein the services hosted on the server include services for initiating a session, adding a transaction to a session, publishing of session and transaction data processing event data, subscribing to session and transaction data processing event data, sharing of content, requesting and receiving input, ending a transaction, and ending a session.

15. A system comprising:
at least one network interface device;
at least one processor; and
at least one memory device storing instructions executable by the at least one processor to perform data processing activities, the data processing activities comprising:
providing a set of services accessible via the at least one network interface device to end-point applications that enable transacting collaboration sessions: and
facilitating a session via the services between at least two end-point applications, the session initiated by a first end-point application and joined by a second end-point application.

16. The system of claim 15, wherein the first and second end-point applications subscribe to data processing event output initiated by the end-point applications and performed by the services when executed by the at least one processor and to data published to the services by the first and second end-point applications.

17. The system of claim 15, wherein the set of services include services for initiating a session, adding a transaction to a session, publishing of session and transaction data processing event data, subscribing to session and transaction data processing event data, sharing of content, requesting and receiving input, ending a transaction, and ending a session.

18. The system of claim 15, wherein the end-point applications include:
a self-service terminal (SST) application that executes on a computing device that controls operation of an SST; and
a mobile device app.

19. The system of claim 18, wherein the mobile device app is a customer-tailored mobile device app that, when participating in a session to which the SST application is also connected, enables input of additional data to conduct transactions on the SST.

20. The system of 19, wherein the SST is an Automated Teller Machine (ATM).
